(19) United States
(12) Patent Application Publication
(10) Pub. No.: US 2025/0084948 A1
(43) Pub. Date: Mar. 13, 2025

(54) SEWER INSPECTION AND/OR MAINTENANCE SYSTEM WITH A TOOL EXCHANGER SYSTEM

(71) Applicant: iPEK International GmbH, Sulzberg (DE)

(72) Inventors: Vreni Tolsdorf, Kempten (DE); Johannes Wiese, Immenstadt (DE); Simon Schweizer, Kempten (DE); Anton Krämer, Kempten (DE)

(21) Appl. No.: 18/883,997

(22) Filed: Sep. 12, 2024

(30) Foreign Application Priority Data
Sep. 13, 2023 (DE) 10 2023 124 742.5

(51) Int. Cl. F16L 55/18; F16L 55/30; F16L 101/30

(52) U.S. Cl. CPC F16L 55/18; F16L 55/30; F16L 2101/30

(57) ABSTRACT

A sewer inspection and/or maintenance system is provided, comprising: (A) a carrier system, in particular a crawler, wherein a lifting arm of the carrier system is designed such that a device carrier arranged thereon can be moved between a number of device—changing positions and at least one device—use position; and (B) a device magazine for accommodating a plurality of devices that is arranged on the carrier system.

### CROSS-REFERENCE TO RELATED APPLICATIONS

This application claims priority to German Patent Application Serial No. DE 10 2023 124 742.5, filed Sep. 13, 2023, the entire disclosure of which is hereby incorporated herein by reference in its entirety.

### FIELD OF THE INVENTION

The invention relates to a sewer inspection and/or maintenance system comprising a carrier system, wherein the sewer inspection and/or maintenance system is adapted to carry out a tool exchange during operation. The carrier system comprises in particular a crawler.

### BACKGROUND OF THE INVENTION

Sewer inspection systems or sewer maintenance systems are known from the prior art, for example from EP 2 689 227 A1. FIG. 1 shows the system known from EP 2 689 227 A1. The system consists of a crawler F and a lifter H arranged thereon. In this case, an inspection camera IK is arranged on the free end of the lifter H. The inspection camera has its own specific interface. The free end of the lifter H has a specific interface corresponding to the interface of the inspection camera. The inspection camera can thus be removed from the lifter and reattached.

It is disadvantageous here that the interface between the inspection camera and the lifter is specific to the inspection camera. This means that only inspection cameras with exactly one such an interface can be attached to the lifter. If a camera has a different interface, it is common to use a correspondingly adapted lifter. That is, different lifters are provided for cameras with different interfaces, which lifters may need to be replaced.

Another disadvantage is that to change the camera, the system has to be taken out of the sewer, and then can be put back into the sewer after changing the camera and the lifter. Long setup times can lead to a considerable loss of time during a sewer inspection.

### OBJECT OF THE INVENTION

The object of the present invention is therefore to provide solutions that make it possible to change a device during ongoing operation, i.e. when the system is in the sewer.

### SUMMARY OF THE INVENTION

This object is achieved using a method according to the independent claims. Advantageous embodiments of the invention are set forth in the specific dependent claims.

Accordingly, a sewer inspection and/or maintenance system is provided comprising a carrier system, in particular a crawler, wherein:
a lifting arm is arranged on the carrier system, on the free end of which a device carrier is arranged,
the device carrier has a first adapter,
the lifting arm is designed such that the device carrier arranged thereon can be moved between a number of device changing positions and at least one device use position,
a device magazine for accommodating a number of devices is arranged on the carrier system, wherein the devices each comprise a second adapter which corresponds to the first adapter of the device carrier, wherein the device is detachably attachable to the device carrier by means of the first adapter and the second adapter of a device,
the lifting arm with a device attached to the first adapter can be moved into a first device changing position, wherein the first adapter, in the first device changing position, is designed to release the device attached to the first adapter from the first adapter, and
the lifting arm can be moved into a second device changing position without a device attached to the first adapter, wherein the first adapter, in the second device changing position, is designed to attach a device accommodated in the device magazine to the first adapter.

This makes it possible to use different devices during ongoing operation (in the sewer) without having to remove the sewer inspection and/or maintenance system from the sewer in order to carry out a tool exchanger.

The sewer inspection and/or maintenance system can have a locking device assigned to the first adapter and the second adapter, with which a device arranged on the first adapter can be temporarily locked to the first adapter.

It is advantageous if the locking device comprises at least one controllable locking means arranged on the first adapter, wherein the locking means is movable with respect to the device carrier between a locked position and an unlocked position.

In the device magazine, a predetermined position within the device magazine can be provided for each device accommodated therein. This makes it easy to realize a fully automatic tool exchange.

The device magazine can have a securing device for a device accommodated therein, with which the device can be releasably lockable in the device magazine after being accommodated in the device magazine.

The securing device can be designed as a controllable securing device that can be controlled in such a way that:
a releasing of a locking of a device to be removed from the device magazine with the lifting arm does not take place until the device is attached to the first adapter, and
a locking of a device to be placed into the device magazine with the lifting arm takes place before the device is released from the first adapter.

It is advantageous if the lifting arm is designed in such a way that the device carrier can be freely positioned in a sewer or pipe with regard to a plurality of degrees of freedom.

Also provided is a sewer inspection and/or maintenance system comprising a carrier system, in particular a crawler or transport sled, wherein a device magazine for accommodating a number of devices is arranged on the carrier system. A device magazine in the sense of the invention is a storage unit in which various devices can be stored and removed.

It can be advantageous if in the sewer inspection and/or maintenance system:
a lifting arm is arranged on the carrier system, on the free end of which a device carrier is arranged,
the device carrier has a first adapter,
the lifting arm is designed such that the device carrier arranged thereon can be moved between a number of device changing positions and at least one device use position,
the devices each have a second adapter which corresponds to the first adapter of the device carrier, wherein the device can be detachably attached to the device carrier by means of the first adapter and the second adapter of a device,
the lifting arm with a device attached to the first adapter can be moved into a first device changing position, wherein the first adapter, in the first device changing position, is designed to release the device attached to the first adapter from the first adapter, and
the lifting arm can be moved into a second device changing position without a device attached to the first adapter, wherein the first adapter, in the second device changing position, is designed to attach a device accommodated in the device magazine to the first adapter.

The invention further provides a crawler of a sewer inspection and/or maintenance system, wherein:
a device magazine is arranged on the crawler, or
the crawler has a device magazine to accommodate a number of devices.

### BRIEF DESCRIPTION OF THE DRAWINGS

Further details and features of the invention as well as specific, particularly advantageous embodiments of the invention will be apparent from the following description in conjunction with the drawing. In the figures:

FIG. 1 shows a sewer inspection system known from the prior art with a lifter on which an inspection camera is arranged;

FIGS. 2A and 2B show a sewer inspection and/or maintenance system according to the invention with a device carrier and a detail view of a device carrier according to the invention;

FIGS. 3A-3D show an adapter of a device carrier according to the invention according to a first embodiment;

FIGS. 4A and 4B show an adapter of a device carrier according to the invention according to a further embodiment;

FIG. 5 shows a sewer inspection and/or maintenance system according to the invention with a device magazine arranged on the carrier device;

FIG. 6 shows a schematic detail view of a device magazine; and

FIG. 7 shows a block diagram of a sewer inspection and/or maintenance system according to the invention.

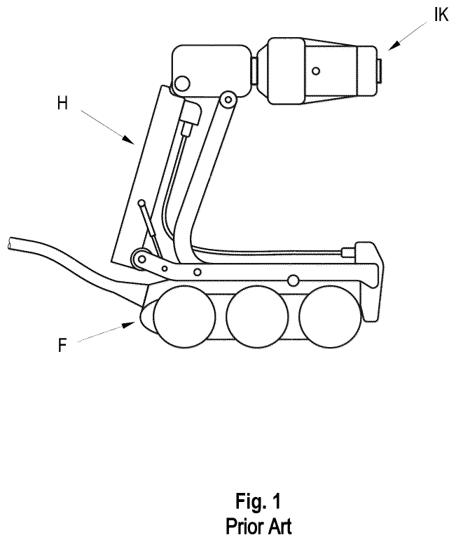

### DETAILED DESCRIPTION OF THE INVENTION

The present invention makes it possible to detachably attach various devices to a carrier system, in particular a crawler or slide bar, by means of the device carrier, without modules or components of the carrier system having to be adapted or replaced. This is made possible by the adapters and interface devices of the device carrier and the devices. The devices can be devices from different device classes such as tools or inspection units. The tools can include, for example, milling cutters, gripping tools, rinsing nozzles, or the like. The inspection units can include e.g. cameras or other sensor systems.

According to the invention, the devices can also comprise devices as well as equipment and systems that remain in the sewer after an inspection or maintenance, such as RFID components, monitoring devices, or the like.

The device magazine and the device carrier make it possible to take various devices into the sewer in different ways. The sewer inspection and/or maintenance system can therefore carry out a tool exchange as needed without having to remove the system from the sewer. The device carrier can also accommodate equipment and systems that remain in the sewer after an inspection or maintenance—the device magazine is advantageously adapted to take such equipment and systems into the sewer.

“Take into the sewer” means that the carrier system on which the device magazine is arranged can be brought into the sewer together with the devices stored in the device magazine, and can be moved there to the desired location in the sewer.

In one embodiment of the invention, the device carrier, which has an adapter and an interface device, and the device magazine can be combined so that in a further aspect of the invention, the invention also provides a sewer inspection and/or maintenance system comprising a carrier system, in particular a crawler, and a number of different devices, wherein:
a lifting arm is arranged on the carrier system, on the free end of which a device carrier is arranged,
the device carrier has a first adapter,
the lifting arm is designed such that the device carrier arranged thereon can be moved between a number of device changing positions and at least one device use position,
a device magazine for accommodating the number of devices is arranged on the carrier system, wherein the devices each comprise a second adapter which corresponds to the first adapter of the device carrier, wherein the device is detachably attachable to the device carrier by means of the first adapter and the second adapter of a device,
the lifting arm with a device attached to the first adapter can be moved into a first device changing position, wherein the first adapter, in the first device changing position, is designed to release the device attached to the first adapter from the first adapter, and
the lifting arm can be moved into a second device changing position without a device attached to the first adapter, wherein the first adapter, in the second device changing position, is designed to attach a device accommodated in the device magazine to the first adapter.
the device carrier has a first interface device, and the number of different devices each have a second interface device, wherein the first interface device corresponds to the second interface device,
the first interface device has a number of first connections, and the second interface device has a number of second connections, wherein at least one connection of the first connections can be coupled to at least one connection of the second connections when a device of the number of different devices is attached to the device carrier.

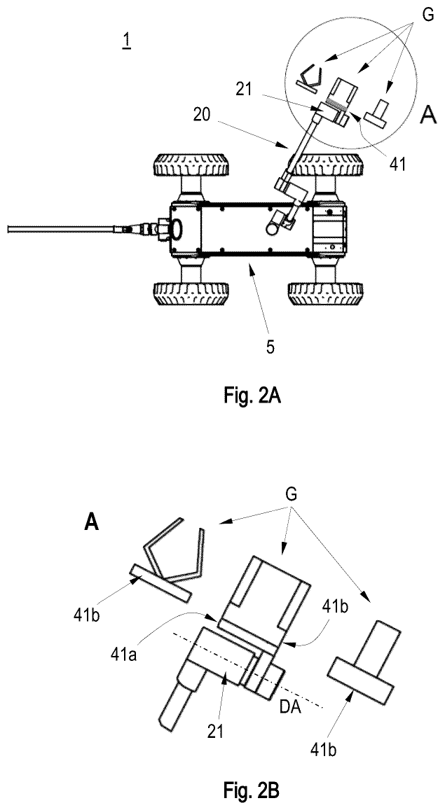

FIGS. 2A and 2B show a sewer inspection and/or maintenance system 1 according to the invention with a device carrier 21 (FIG. 2A) and a detail view of a device carrier according to the invention (FIG. 2B).

The sewer inspection and/or maintenance system 1 comprises a carrier system 5 which is designed here as a crawler. Instead of a crawler, a carrier sled or similar can also be used.

A lifting arm 20 is arranged on the crawler 5, which arm advantageously has a plurality of arm portions coupled to one another in an articulated manner. It is advantageous if the arm portions are movable relative to one another, and the lifting arm 20 as such is movable relative to the crawler 5. It is also advantageous if each arm portion is assigned an adjusting means with which the arm portion can be moved relative to the arm portion to which it is articulated. This allows the free end of the lifting arm 20 to be moved as desired.

At the free end of the lifting arm 20, a device carrier 21 is arranged which can also be detached from the lifting arm 20 as needed (i.e. optionally), for example for maintenance purposes.

The device carrier 21 can be designed to be rotatable about a rotation axis DA so that the device arranged on the device carrier 21 can be pivoted about this axis DA if required.

According to the invention, it is provided that different devices G can be arranged on the device carrier 21, in particular detachably arranged. For this purpose, an adapter system 41 is provided which basically comprises a first adapter 41a and a second adapter 41b, wherein the first adapter 41a is assigned to the device carrier 21 and the second adapter 41b is assigned to the device G.

The two adapters, i.e. the adapter 21a of the device carrier 21 and the adapter 21b of the device, are designed such that they correspond to each other, and the device can preferably be temporarily locked to the device carrier. For this purpose, the adapter system 41 can comprise a locking device (not shown here). It is advantageous if the locking device comprises at least one controllable locking means arranged on the first adapter, i.e. on the adapter 41a of the device carrier. The locking device can thus be coupled to a control device of the crawler (carrier system), which can then control and monitor the locking process.

The locking means can comprise, for example, a radially extending pin which, when locked, can be brought into engagement with a blind hole present on the adapter 41b of the device and extending radially there. According to another example, the locking means can also comprise a type of clamping device into which the adapter of the device can be clamped. In principle, any type of locking device can be used as long as it is suitable for locking the device with the adapter of the device to the adapter of the device carrier.

In order to prevent incorrect (incorrectly positioned) accommodation of a device by the device carrier, it has proven advantageous if the two adapters 21a and 21b are designed in such a way that arranging a device on the device carrier is only possible in a predetermined position of the adapter 41b of the device relative to the adapter 41a of the device carrier. This can be achieved, for example, by the geometry of the two adapters, or by positioning pins on the adapter of the device carrier (or on the adapter of the device) that can be brought into engagement with positioning holes in the adapter of the device (or in the adapter of the device carrier); of course, the positioning pins and positioning holes are arranged in such a way that they can only be brought together in a predetermined position of the two adapters in relation to each other.

The adapter system can be designed such that the adapter 41a of the device carrier and the adapter 41b of the device can be coupled to one another fluid-tight (gas- and liquid-tight). This can prevent dirt, liquids or gases from penetrating into the intermediate area of the adapter system during a sewer inspection or sewer maintenance.

Figure FIG. 2A shows, by way of example, three devices G which can be arranged on the device carrier 21 by means of the two adapters 21a and 21b. Due to the interface device designed according to the invention, which is described below, devices of different device classes (sensor systems, cameras, normal tools, fluid-carrying tools such as rinsing nozzles, and the like) can be detachably attached to the device carrier.

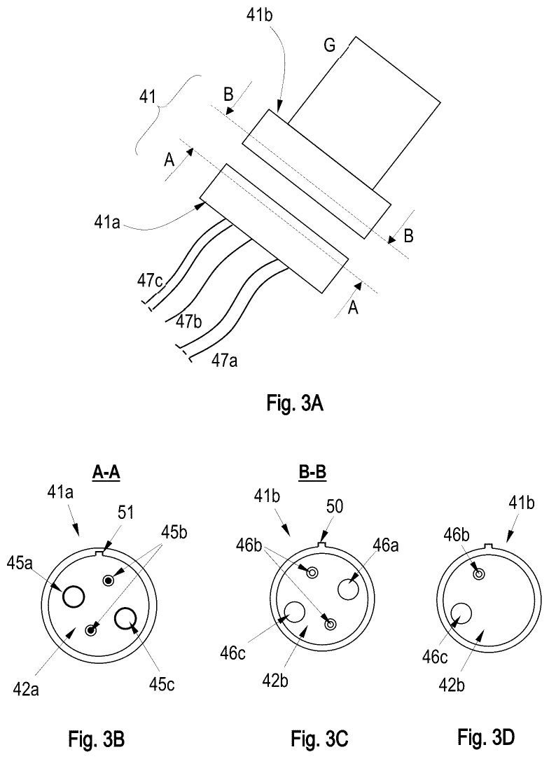

FIGS. 3A-3D show an adapter system 41 of a device carrier according to the invention according to a first embodiment. FIG. 3A schematically shows the adapter system 41, FIG. 3B shows a section of the first adapter 41a along the section axis A-A, FIG. 3C shows a section of the second adapter 41b along the section axis B-B, and FIG. 3D shows an alternative embodiment of the second adapter.

The adapter system 41 comprises an adapter 41a assigned to the device carrier and an adapter 41b assigned to the device G, wherein the device carrier is not shown in FIGS. 3A-3D. “Assigned to the device carrier” or “assigned to the device” means that the device carrier/device has the adapter in question, or the adapter in question is an integral part of the device carrier/device.

In the adapter system shown in FIGS. 3A-3D, the adapters 41a and 41b each have a largely round cross section, wherein the adapter 21b of the device can be brought into engagement with the adapter 21a of the device carrier. The outer diameter of the adapter 21b here substantially corresponds to the inner diameter of the adapter 21a. Of course, a reverse configuration with corresponding diameters is also possible; i.e. the adapter 41a engages in the adapter 41b.

The two adapters 41a, 41b have positioning means which ensure that the two adapters can only be brought into engagement in a particular position relative to each other. For this purpose, the second adapter 41b has a radially outwardly projecting positioning pin 50 which engages in a corresponding recess 51 in the first adapter 41a when the two adapters 41a, 41b are brought together. Of course, other positioning means are also possible which ensure that the two adapters can only be brought together in a certain way. Another type of positioning means is the geometry of the adapters—for example, the outer circumference of the second adapter and the inner circumference of the first adapter can have a polygonal shape, where the joining of the two adapters is only possible in a particular position relative to each other.

According to the invention, the device carrier has a first interface device 42a, and the devices G each have a second interface device 42b. Both interface devices 42a, 42b are designed such that they correspond with each other. For this purpose, the first interface device 42a has a number of first connections 45a; 45b; 45c, and the second interface device 42b has a number of second connections 46a; 46b; 46c, wherein at least one connection of the first connections 45a; 45b; 45c can be coupled to at least one connection of the second connections 46a; 46b; 46c when a device is attached to the device carrier (by means of the adapters 41a, 41b). This means that the two interface devices 42a, 42b can also have a different number of connections as long as a connection of the first interface device 42a can be coupled to a connection of the second interface device 42b when a device is attached to the device carrier.

FIG. 3B shows a first adapter 41a of a device carrier, and FIG. 3C shows a second adapter 41b of a device. In this case, these two adapters or the two interface devices 42a and 42b each have four connections 45a; 45b; 45c or 46a; 46b; 46c, with the connections 45b and 46b being present twice here. The connections of the first interface devices 42a can each be coupled to a connection of the second interface devices 42b; for example, connection 45a can be coupled to connection 46a, connection 45b can be coupled to connection 46b, and connection 45c can be coupled to connection 46c.

FIG. 3D shows an alternative embodiment of the interface devices 42b of the second adapter 41b. These interface devices 42b according to FIG. 3D can nevertheless be coupled to the interface devices 42a according to FIG. 3B since the connection 46b can be coupled to the connection 45b, and the connection 46c can be coupled to the connection 45c.

The connections 45b can be connections for the transmission of electrical energy and/or connections for the transmission of data. These two connections are designed in the manner of a plug system so that the connection 45b engages in the connection 46b in order to thus establish an electrical contact between the two connections. Alternatively, the connections for transmitting electrical energy and/or for transmitting data can also be designed as contactless connections if, for example, the electrical energy/data is transmitted on an inductive or capacitive basis.

The connections 45a, 46a can be hydraulic connections which can be used, for example, to supply a fluid, e.g. water, to a device G designed as a cleaning nozzle. The hydraulic connections are preferably designed such that they can be coupled pressure- and fluid-tight.

The connections 45c, 46c can be pneumatic connections which can be used, for example, to supply a gas, e.g. air, to a device G. For example, the gas supplied to the device can be used to pneumatically operate an actuator on the device. The pneumatic connections are preferably designed so that they can be coupled pressure-tight.

If the adapter 41b according to FIG. 3D is coupled to the adapter 41a according to FIG. 3B, then the terminals 46b and 46c of the interface device 42b are coupled to the corresponding connections 45b and 45c of the interface device 42a. The connections 45a and the other of the two connections 45b are not required for the device used. In this case, it can be advantageous to provide a shut-off device, for example in the form of a valve, at least for the connection 45a.

The connections are each coupled to corresponding lines or supply lines 47a, 47b, 47c. For example, the connections 45a (hydraulic connection) and 45c (pneumatic connection) can each be coupled to a high-pressure hose. The connections 45b can be coupled to data and/or power lines.

If, in the case of an adapter 41b as shown in FIG. 3D, the connection 45a of the adapter 41a as shown in FIG. 3B is not required, the above shut-off device can also be provided in the corresponding supply line.

A device designed as a camera can, for example, have an air nozzle with which a kind of air curtain is formed in front of the camera lens that prevents dust or other particles from reaching the lens when the camera is in operation. The interface device 42b of such a camera can have a data connection, a power connection, and a pneumatic connection. Nevertheless, this interface device 42b can be coupled to the interface device 42a shown in FIG. 3B (the hydraulic connection 45a is present but is not required).

The interface device 42b of a device designed as a rinsing nozzle with a camera can have a data connection, a power connection, and a hydraulic connection. However, this interface device 42b can be coupled to the interface device 42a shown in FIG. 3B (the pneumatic connection 45c is present but is not required).

In another example, a camera without any additional functions is used as the device. In this case, the interface device 42b can have a data connection and a power connection. Nevertheless, this interface device 42b can be coupled to the interface device 42a shown in FIG. 3B (the pneumatic connection 45c and the hydraulic connection 45a are present but are not required).

In the same way, a rinse head without any other function can be used as a device. In this case, it is sufficient if the interface device 42b has only one hydraulic connection. Nevertheless, this interface device 42b can be coupled to the interface device 42a shown in FIG. 3B (the pneumatic connection 45c and the two connections 45b are present but not required).

In one embodiment of the invention, the devices can each have an identifier that enables the sewer inspection and/or maintenance system to determine which device is currently arranged on the device carrier.

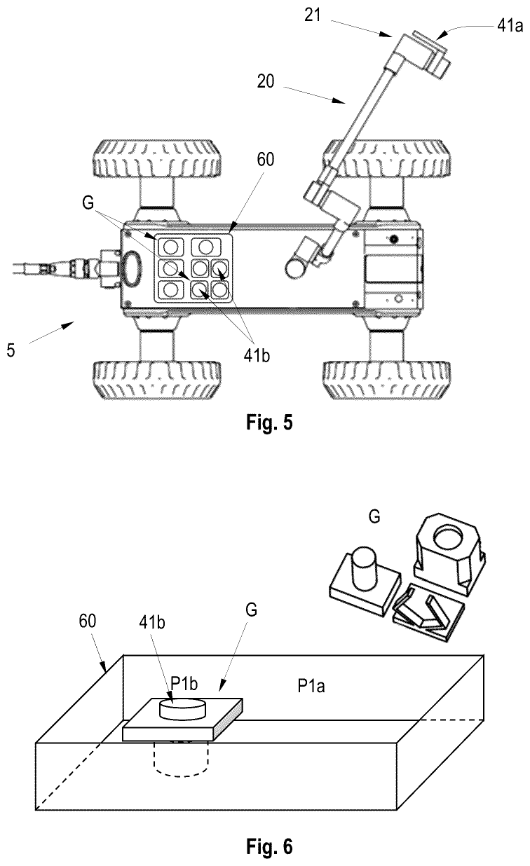

The identifier can be stored in a storage means arranged on or in the device, and the device carrier or the adapter of the device carrier can have a reading device with which the identifier can be read from the storage means of the device arranged on the device carrier. The storage means can be an RFID tag that can be read with a reading device designed as an RFID reader. Alternatively, the storage means can also be a barcode or QR code (which stores the identifier in coded form) that can be read with a reading device designed as a barcode or QR code reader. When using a device magazine as described below with reference to FIG. 5, such an identifier can also be omitted if it is known which device is located where in the device magazine. However, the use of an identifier is advantageous when a device is manually attached to the device carrier. In this case, the system can automatically determine which device is on the device carrier.

If it is known which device is located on the device carrier, a control device of the system, such as a control device on the crawler or a control device located outside the sewer, can automatically deactivate the lines/supply lines that are not required. For this purpose, the control device can be adapted in such a way that it prevents an operator from inadvertently activating an unnecessary supply line.

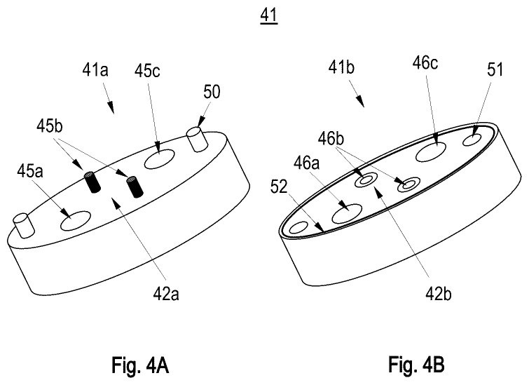

FIGS. 4A and 4B show an adapter system 41 of a device carrier according to the invention according to a further embodiment. FIG. 4A schematically shows a first adapter 41a of the tool carrier, and FIG. 4B schematically shows a second adapter 41b of the device.

In contrast to the adapter system shown in FIGS. 3A-3D, in this case the two adapters 41a and 41b do not mesh with each other. For this reason, it may be advantageous to provide a circumferential sealing ring on the adapter 41a and/or the adapter 41b.

The function and mode of operation of the two interfaces 42a and 42b corresponds to the function and mode of operation of the two interfaces described with reference to FIGS. 3A-3D.

In contrast to the adapter system described in FIGS. 3A-3D, in this case two axially protruding positioning pins 50 are arranged on the first adapter 41a, which engage in corresponding recesses 51 in the second adapter 41b.

The adapter system shown in FIGS. 4A-4B also provides locking means (not shown here) to lock the first adapter to the second adapter.

The device carrier and the adapter system described above, including the interface system, can be used advantageously to attach different devices, for example to a lifting arm, without having to adapt the lifting arm for this purpose. However, they are particularly advantageous when the devices have to be replaced during operation, i.e. when the inspection and/or maintenance system is in the sewer. This is now possible without having to remove the inspection and/or maintenance system from the sewer.

According to a further aspect of the invention, the carrier system such as a crawler has a device magazine for accommodating a number of devices.

A carrier system 5 with a device magazine arranged thereon is shown in FIG. 5, and a schematic view of a device magazine is shown in FIG. 6.

The carrier system 5, which is designed here as a crawler, has a lifting arm 20 at the free end of which a device carrier 21 is arranged, as described above. The device carrier 21 has a first adapter 41a which corresponds to the first adapter described above. A number of devices G are arranged in the device magazine 60, with seven devices being located in the device magazine 60 in FIG. 5. The devices each have a second adapter 41b which corresponds to the second adapters described above.

By means of the first adapter 41a and the second adapter 41b, a device can be detachably fastened to the device carrier 21, wherein it is possible according to the invention for the device that is to be fastened to be arranged in the device magazine 60.

In order to pick up a device from the device magazine 60 with the device carrier 21 arranged on the lifting arm, it is provided according to the invention that the lifting arm 20 is designed such that the device carrier 21 arranged thereon can be moved between a number of device changing positions P1 and at least one device use position P2. When there are n devices in the device magazine 60, the device carrier 21 can therefore assume n device changing positions P1.

When changing the device, the lifting arm 20 with a device attached to the first adapter 41a is moved into a first device changing position P1a, wherein the first adapter 41a is designed to release the device attached to the first adapter 41a from the first adapter 41a in the first device changing position P1a, i.e. to place the device in the device magazine. The first device changing position P1a in this case corresponds to a position in or on the device magazine at which the device is placed in the magazine.

Subsequently, the lifting arm 20 is moved into a second device changing position P1b without a device attached to the first adapter 41a, wherein the first adapter 41a is designed, in the second device changing position P1b, to attach a device G accommodated in the device magazine 60 to the first adapter 41a. The second device changing position P1b in this case corresponds to a position in or on the device magazine at which the device to be picked up is located in the magazine.

As described above, the first adapter 41a and the second adapter 41b have a locking device (not shown here) with which a device G arranged on the first adapter 41a or picked up from the device magazine can be temporarily locked to the first adapter.

The locking device can comprise at least one controllable locking means arranged on the first adapter 41a, wherein the locking means is movable with respect to the device carrier 21 between a locked position and an unlocked position. When a device is placed in the device magazine, the locking means is moved from the locked position to the unlocked position, and thus the device attached to the adapter 41a is released from the adapter 41a. To pick up, or when picking up, a device from the device magazine, the locking device is in the unlocked position. After the device has been arranged on the first adapter 41a, the locking means is moved from the unlocked position to the locked position. The device is now firmly connected to the device carrier. The locking device can correspond to the locking device described above with reference to FIGS. 2A and 2B.

In one embodiment of the invention, it can be provided that the locking means is moved from the locked position to the unlocked position when the lifting arm or the device carrier is not in a device changing position. As explained above, the device can be a device that remains in the sewer after an inspection or after maintenance, such as monitoring units or the like. Such devices can also be accommodated in the device magazine and advantageously have a second adapter, as described above. With the aid of the device carrier 21 according to the invention, such devices can be removed from the device magazine and placed at a predetermined location in the sewer. Such devices are also subsequently referred to as “lost” devices.

It can be advantageous if lost devices also have a unique identifier or have a storage means in which a unique identifier of the device is stored. In an advantageous embodiment, the storage means is a writable storage means, such as an RFID tag. The identifier can be read from the storage means using a reading device arranged on the device carrier or on the adapter of the device carrier. In one embodiment of the invention, in addition to the reading device, a writing device can also be provided on the device carrier or on the adapter of the device carrier (or alternatively a writing/reading device) with which information can be written to the storage means. For example, when a lost device is placed in the sewer, the system can write the position of the lost device in the sewer to the storage means.

It is advantageous if, in the device magazine, a predetermined position within the device magazine is provided for each device accommodated therein. A control device with which the lifting arm is controlled can thus move or control the lifting arm independently (i.e. without human intervention) to the corresponding device changing position and can pick up the device placed there. An operator thus only has to indicate at an input device which device is to be picked up with the device carrier. The control device then automatically causes the device attached to the device carrier to be placed in the device magazine (if a device is attached to the device carrier) and automatically picks up the desired device from the device magazine.

Since a predetermined position in the device magazine is also provided for the device to be placed in the device magazine, the control device can also move or control the lifting arm to the corresponding device changing position.

The above-mentioned identifier can be used to ensure that the control device always knows which device is currently arranged on the device carrier. If devices are only taken from the device magazine, the control device knows which device is currently on the device carrier even without such an identifier.

The picking up and placing of devices from or into the device magazine can thus be completely automated.

The device magazine 60 optionally has a securing device (not shown here) for a device G accommodated therein, with which the device can be releasably locked in the device magazine 60 after being accommodated in the device magazine 60. The securing device ensures that the device does not fall out of the device magazine during operation of the sewer inspection and/or maintenance device, which could be the case for example due to vibrations of the crawler. The securing device can for example be a magnet. The securing device can however also include grippers or locking devices.

In an advantageous embodiment of the invention, the securing device can be designed as a controllable securing device. Advantageously, it can be controlled in such a way that a locking of a device to be removed from the device magazine 60 with the lifting arm 20 is not released until the device is attached to the first adapter 41a. Whether the device is attached to the first adapter can be determined by means of the locking device associated with the first adapter (for locking a device to the first adapter), in particular if it is a controllable locking device.

Furthermore, it is advantageous if the securing device can be controlled in such a way that a device to be placed in the device magazine 60 is locked before the device is released from the first adapter 41a. For this purpose, the control device of the crawler can be designed such that the device is not released from the first adapter 41a until the device is locked in the device magazine 60.

In both cases, this ensures that a device is at no time in an unsecured state.

The lifting arm 20 is designed such that the device carrier 21 can be freely positioned in a sewer or pipe with regard to a plurality of degrees of freedom, i.e. can be moved in all directions. It can also be advantageous if the device carrier itself is arranged so that it can rotate and/or pivot on the lifting arm.

A combination of the device magazine according to the invention with a device carrier according to the invention and the corresponding adapters of the device carrier and the devices enables a particularly efficient sewer inspection and/or maintenance. All required devices (e.g. inspection camera, rinsing nozzle, milling cutter, lost devices, etc.) can be carried in the device magazine. With the device carrier, the particular required device can be picked up from the device magazine and moved to any position using the lifting arm mentioned above.

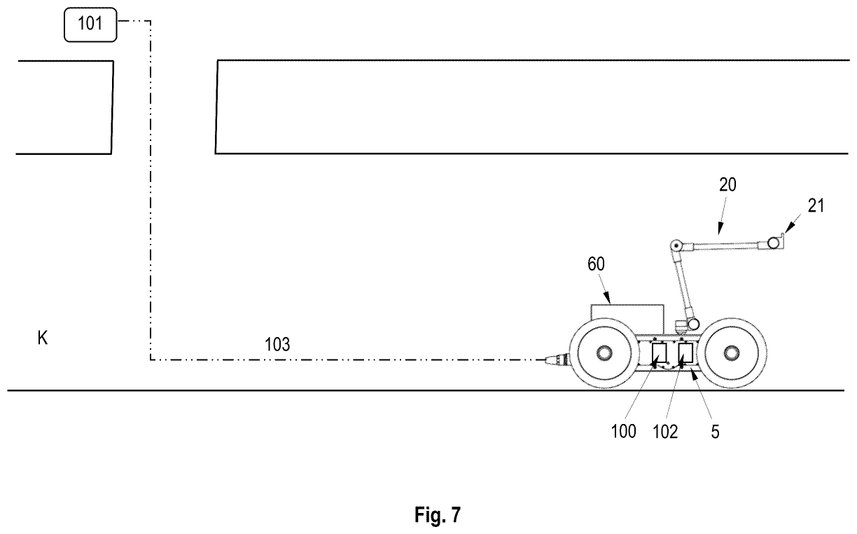

FIG. 7 shows a block diagram of a sewer inspection and/or maintenance system according to the invention.

An inspection and/or maintenance device of an inspection and/or maintenance system is arranged in a sewer K and can be moved in the sewer. The inspection and/or maintenance device has a crawler 5 as a carrier system on which an articulated lifting arm 20 is arranged. The lifting arm in this case has two lifting arm segments which are coupled to one another in an articulated manner, wherein the two lifting arm segments can be moved relative to one another by an actuator. At the free end of the lifting arm, a device carrier 21 is arranged which, as described above, has a first adapter which in turn has controllable locking means for locking an accommodated device. The other end of the lifting arm is pivotably and/or rotatably connected to the crawler, appropriate adjustment means being provided for the pivoting/rotating. The crawler can have a drive controller 102 with which the drive units of the crawler wheels can be controlled.

The inspection and/or maintenance system in this case further comprises an operating unit 101 which is coupled to a control device 100 of the inspection and/or maintenance device via a communication connection 103. The communication connection 103 can be wired or wireless.

The control device 100 is in turn coupled or connected to the drive controller 102, to the device magazine 60, to the actuating means of the lifting arm 20 or the lifting arm segments, and to the device carrier 21. The adapter or the controllable locking means of the adapter can be controlled by means of the control device 100. The above-described changing of a device can also be carried out by means of the control device 100. Furthermore, the securing device of the device carrier can also be controlled by means of the control device 100, as also described above.

The control device 100 is in this case part of the shown inspection and/or maintenance device 5. In an alternative embodiment of the invention, the control device 100 can also be part of the operating unit, or the function of the control device 100 can be taken over by the operating unit.

We claim:

1. A sewer inspection and/or maintenance system comprising a carrier system, in particular a crawler, wherein:
a lifting arm is arranged on the carrier system, at the free end of which a device carrier is arranged,
the device carrier comprises a first adapter,
the lifting arm is designed such that the device carrier arranged thereon can be moved between a number of device changing positions and at least one device use position,
a device magazine for accommodating a number of devices is arranged on the carrier system, wherein the devices each comprise a second adapter which corresponds to the first adapter of the device carrier, wherein the device is detachably attachable to the device carrier by means of the first adapter and the second adapter of a device,
the lifting arm is movable, with a device attached to the first adapter, into a first device changing position, wherein the first adapter, in the first device changing position, is designed to release the device attached to the first adapter from the first adapter, and
the lifting arm can be moved into a second device changing position without a device attached to the first adapter, wherein the first adapter, in the second device changing position, is designed to attach a device accommodated in the device magazine to the first adapter.

2. The sewer inspection and/or maintenance system according to claim 1, wherein this system has a locking device assigned to the first adapter and the second adapter, with which a device arranged on the first adapter can be temporarily locked to the first adapter.

3. The sewer inspection and/or maintenance system according to claim 2, wherein the locking device comprises at least one controllable locking means arranged on the first adapter, wherein the locking means is movable with respect to the device carrier between a locked position and an unlocked position.

4. The sewer inspection and/or maintenance system according to claim 1, wherein, in the device magazine, a predetermined position within the device magazine is provided for each device accommodated therein.

5. The sewer inspection and/or maintenance system according to claim 1, wherein the device magazine has a securing device for a device accommodated therein, with which the device can be releasably locked in the device magazine after being accommodated in the device magazine.

6. The sewer inspection and/or maintenance system according to claim 5, wherein the securing device is designed as a controllable securing device which is controllable in such a way that:
a locking of a device to be removed from the device magazine with the lifting arm is not released until the device is attached to the first adapter, and
a device to be placed into the device magazine with the lifting arm is locked before the device is released from the first adapter.

7. The sewer inspection and/or maintenance system according to claim 1, wherein the lifting arm is designed such that the device carrier can be freely positioned in a sewer or pipe with respect to a plurality of degrees of freedom.

8. A sewer inspection and/or maintenance system comprising a carrier system, in particular a crawler, wherein a device magazine for accommodating a number of devices is arranged on the carrier system.

9. A sewer inspection and/or cleaning system according to claim 8, wherein:
a lifting arm is arranged on the carrier system, at the free end of which a device carrier is arranged,
the device carrier comprises a first adapter,
the lifting arm is designed such that the device carrier arranged thereon can be moved between a number of device changing positions and at least one device use position,
the devices each comprise a second adapter which corresponds to the first adapter of the device carrier, wherein the device is detachably attachable to the device carrier by means of the first adapter and the second adapter of a device,
the lifting arm is movable, with a device attached to the first adapter, into a first device changing position, wherein the first adapter, in the first device changing position, is designed to release the device attached to the first adapter from the first adapter, and
the lifting arm can be moved into a second device changing position without a device attached to the first adapter, wherein the first adapter, in the second device changing position, is designed to attach a device accommodated in the device magazine to the first adapter.
